(19) United States
(12) Patent Application Publication
(10) Pub. No.: US 2005/0140693 A1
(43) Pub. Date: Jun. 30, 2005

(54) Display system

(75) Inventors: Hyun-suk Kim, Suwon-si (KR); Se-woong Park, Suwon-si (KR); Kil-soo Park, Suwon-si (KR); Jin-bog Kim, Hwasung-si (KR); Man-yong Shin, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/930,916

(22) Filed: Sep. 1, 2004

(30) Foreign Application Priority Data
Sep. 1, 2003 (KR) 2003-60946

(51) Int. Cl. G09G 5/02

(52) U.S. Cl. 345/600

(57) ABSTRACT

A display system to display an image resulting from an image signal, comprising a color converting part which converts the image signal to change a color distributed in a color area grouped by a plurality of colors and formed as one of a variety of geometric shapes in a color space and the color is changed within the color area. The user interface generator provides one or more user interface components to visually accommodate the color change in the respective color areas without affecting the rest of the image.

### CROSS-REFERENCE TO RELATED APPLICATION

This application claims the benefit of Korean Patent Application No. 2003-60946, filed Sep. 1, 2003, in the Korean Intellectual Property Office, the disclosure of which is incorporated herein by reference.

### BACKGROUND OF THE INVENTION

1. Field of the Invention

The present invention relates to a display system, and more particularly, to a display system which converts a color distributed only in a particular color area of a color space, a method of operating, and a user interface method thereof.

2. Description of the Related Art

Display apparatuses, especially color display apparatuses, are widely used in display devices to present information in a visual form. Examples of display devices that utilize display apparatuses include TVs, DTVs (Digital TVs), projectors, TFT (Thin Film Transistor) monitors, TFT TVs, color printers, digital cameras, cell phones, and so on.

Generally, in a conventional display apparatus the condition of displayed images is controlled by changing the properties of hue, brightness, and saturation of an image signal supplied to the display apparatus. For example, the color of an image displayed in a display apparatus can be controlled by increasing or decreasing the saturation and/or hue (color) components of a colored portion of the image signal input to the display apparatus.

However, when the color components and/or saturation of a certain color is changed, the color components and/or saturation of all the colors displayed in the display apparatus are changed. For example, when the property settings of a color are changed to increase a red component and decrease saturation for only a skin-tone color in an image displayed in the display apparatus, the entire color of the image displayed therein, including the skin-tone color and other colors associated with a background image are affected. That is, in a conventional display apparatus, changing a certain color of an image, such as the skin-tone color, results in unexpected changes to the rest of the image.

### SUMMARY OF THE INVENTION

Accordingly, it is an aspect of the present invention to provide a display system which is capable of changing one or more color components and/or the saturation of a predetermined color, for example, a skin-tone color, a sky-blue color, or a grass/tree-green color, without affecting the other colors, and therefore, without affecting the rest of the image. That is, it is an aspect of the present invention to provide a display apparatus which changes a color distributed in a certain color area in a color space according to a user's taste or a predetermined setting provided thereto, for example, via the Internet.

Additional aspects and/or advantages of the invention will be set forth in part in the description which follows and, in part, will be obvious from the description, or may be learned by practice of the invention.

To achieve the above and/or other aspects of the present invention, there is a display system to display an image having a color area, the image resulting from an image signal, the display system including a color converter which converts the image signal to change a color distributed in the color area in a color space and the color is changed within the color area of the image.

According to an aspect of the present invention, the color area is grouped by a plurality of colors and is formed as one of a variety of geometric shapes including complex geometric shapes in the color space.

According to an aspect of the present invention, the color converter sets a predetermined color in the color area as a standard color, and determines a conversion degree in color of the other colors in the color area based on a conversion degree in color of the standard color.

According to an aspect of the present invention, the color space may include a YCbCr color space, a CIELAB (Commission International de Eclairage) (L*a*b*) color space, or a CIELUV (L*u*v*) color space.

According to an aspect of the present invention, the color converter changes one or more color components and/or the saturation of the color area without affecting the rest of the image.

According to an aspect of the present invention, the image signal includes a luminance signal and a chrominance signal, and the color converter converts the chrominance signal to change the color in the color area.

According to an aspect of the present invention, the color area may be a memorial color area having memorial color components, the memorial color area being the color of a certain object/thing that a user of a predetermined region is accustomed to and/or perceives as the color of the object/thing.

According to an aspect of the present invention, the color area is an ellipse-like shape in the color space.

According to an aspect of the present invention, the display system further includes a user interface generator, which provides one or more user interface components to visually confirm and accommodate the change of color distributed in the color area.

According to an aspect of the present invention, the display system further includes a user input which operates one or more of the user interface components and generates a key signal to convert the color in the color area.

According to an aspect of the present invention, the display system further includes a controller which controls the display system, the controller adopting one or more image components of the image and/or one or more components obtained via a network, as one or more of the user interface components. According to an aspect of the present invention, the color converter changes the color distributed in the color area according to a predetermined setting obtained via a network.

To achieve the above and/or other aspects of the present invention, there is a display system to display an image having one or more color areas, the image resulting from an image signal, the display system including a color converter which processes the image signal to change colors distributed in the color areas in a color space of the image, and a user interface generator which provides one or more user interface components to accommodate the color change in the respective color areas.

According to an aspect of the present invention, the user interface generator provides one or more color control bars and a converted image display window having one or more converted images that correspond to the one or more color areas, so as to visually confirm and accommodate the change of colors distributed in the color areas by operating the respective color control bars.

According to an aspect of the present invention, the user interface generator provides one or more converted image display windows that correspond to the one or more color areas, and each of the converted display windows includes a converted image and a color control bar so as to visually confirm and accommodate the change of colors distributed in the color areas by operating the respective color control bars. According to an aspect of the present invention, the user interface generator further provides one or more standard image display windows corresponding to the one or more color areas, and each of the standard image display windows includes a standard image that corresponds to a respective one of the converted images so as to visually facilitate a before and after comparison.

According to an aspect of the present invention, the color converter changes one or more color components of a selected one of the color areas without affecting the rest of the color areas and/or the image. According to an aspect of the present invention, the color areas include skin-tone color, sky-blue color and grass/tree-green color areas.

According to an aspect of the present invention, the display system adopts one or more image components of the image signal and/or one or more components obtained via a network, as one or more of the user interface components. According to an aspect of the present invention, the color converter processes one or more of the color areas to change color according to a predetermined setting obtained via a network.

To achieve the above and/or other aspects of the present invention, there is a display system to display an image having a color area, the image resulting from an image signal, the display system including a user interface generator which provides one or more user interface components to visually confirm and accommodate a change in a color or colors distributed in the color area in a color space of the image. According to an aspect of the present invention, the user interface generator adopts one of a pre-stored component, an image component of the image signal, and a component obtained via a network as one of the user interface components.

To achieve the above and/or other aspects of the present invention, there is a display system to display an image having one or more color areas, the image resulting from an image signal, the display system including a user interface generator which provides one or more reference images requesting a user preferred change in color of the one or more color areas, and presents the one or more reference images to visually indicate the change in color in real time. According to an aspect of the present invention, the user interface generator further provides one or more standard images corresponding to the one or more reference images for a before and after comparison. According to an aspect of the present invention, the user interface generator further provides one or more color control bars corresponding to the one or more color areas to provide a visual representation of the level of the color change.

To achieve the above and/or other aspects of the present invention, there is a method of operating a display system to display an image having a color area, the image resulting from an image signal for display, the method including providing one or more user interface components which request a user operation to change a color distributed in a color area in a color space, in response to a user preference key signal, and presenting the one or more user interface components to visually indicate the color change according to the user operation. According to an aspect of the present invention, the method further includes converting the image signal according a conversion setting which corresponds to the user operation. According to an aspect of the present invention, the method further includes displaying the image resulting from the converted image signal.

According to an aspect of the present invention, the converting of the image signal includes setting a predetermined color in the color area as a standard color, and determining a conversion degree of the other colors in the color area based on a conversion degree of the standard color.

According to an aspect of the present invention, the converting of the image signal comprises changing one or more color components and/or the saturation of the color area, and/or converting a chrominance signal of the image signal to change the color distributed in the color area, without affecting the rest of the image.

According to an aspect of the present invention, the method further comprises processing the image signal according to a conversion setting corresponding to, and in response to, the user operation, and processing the image signal according to a predetermined setting in response to a signal indicating a preference for a preset color change in the color area.

According to an aspect of the present invention, the providing of the one or more user interface components includes adopting one or more pre-stored components, one or more components of the image signal, and one or more components obtained via a network, or a combination thereof, as the one or more user interface components.

According to an aspect of the present invention, the providing of the one or more user interface components includes providing an operable color control bar and a converted image display window having a converted image corresponding to the color area, so as to visually confirm and accommodate the color change, and the presenting of the one or more user interface components includes presenting the color change implemented to the converted image display in real time. According to an aspect of the present invention, the providing of the one or more user interface components further includes providing a standard image display window having a standard image corresponding to the converted image so as to facilitate a before and after comparison.

To achieve the above and/or other aspects of the present invention, there is a method of changing a color distributed in a color area of an image, the image resulting from an image signal for display, the method including converting an input coordinate value of an input color, corresponding to a color difference signal, into a converted coordinate value in a coordinate system that is set based on the longest and the shortest axis of a geometric shape defining the color area, in response to the input coordinate value not being identical to a coordinate value of a predetermined standard color, wherein the color difference signal is indicative of the hue and/or saturation of the color, determining a color conversion coefficient for a color conversion of the converted coordinate value and a color conversion coordinate value of the input color in response to the input color not being included in the color area, and converting the color difference signal corresponding to the determined color conversion coordinate value.

To achieve the above and/or other aspects of the present invention, there is a method of user interfacing to controllably display an image having one or more color areas, the image resulting from an image signal for display, the method including providing one or more reference images requesting a user predetermined change in color of the one or more color areas, and presenting the one or more reference images to visually indicate the change in color in real time. According to an aspect of the present invention, the method further includes providing one or more standard images corresponding to the one or more reference images for a before and after comparison. According to an aspect of the present invention, the method further includes providing one or more color control bars corresponding to the one or more color areas to provide a visual representation of a level of color change.

To achieve the above and/or other aspects of the present invention, there is a method of changing an image having one or more color areas, the image resulting from an image signal for display, the method comprising providing one or more reference images requesting a user preference change in color of the one or more color areas, and converting the image signal to change the color of the one or more color areas within the respective color areas without affecting the rest of the image, according to the user preference change.

To achieve the above and/or other aspects of the present invention, there is a computer readable medium encoded with operating instructions for implementing a method of operating a display device to display an image having a color area, the image resulting from an image signal for display, performed by a computer, the method comprising providing one or more user interface components requesting a user operation to change a color distributed in a color area in a color space, in response to a user preference key signal, and presenting the one or more user interface components to visually indicate the color change according to the user operation. According to an aspect of the present invention, the operating instructions further comprise processing the image signal according a conversion setting corresponding to the user operation, the processing of the image signal including setting a predetermined color in the color area as a standard color, and determining a conversion degree of the other colors in the color area based on a conversion degree in the color of the standard color.

To achieve the above and/or other aspects of the present invention, there is a method in a computer system to process an image having a color area, the image resulting from an image signal for display, the method comprising controlling a user interface generator to provide one or more user interface components to visually confirm and accommodate a change in color distributed in the color area in a color space and the color is changed within the color area of the image, and controlling a color converter to convert the image signals to change the color in the color area of the image.

### BRIEF DESCRIPTION OF THE DRAWINGS

These and/or other aspects and advantages of the invention will become apparent and more readily appreciated from the following description of the aspects of the present invention, taken in conjunction with the accompanying drawings of which:

FIG. 1 is a control block diagram of a display system according to an embodiment of the present invention;

FIG. 2 is a drawing illustrating a color space and color areas in an XYZ coordinates system, according to an aspect of the present invention;

FIGS. 3 and 4 are XY plane graphs describing a color conversion method according to an aspect of the present invention;

FIG. 5 is a flow chart illustrating a color conversion method according to an aspect of the present invention; and

FIGS. 6 to 8 are drawings illustrating various user interfacing methods according to several aspects of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

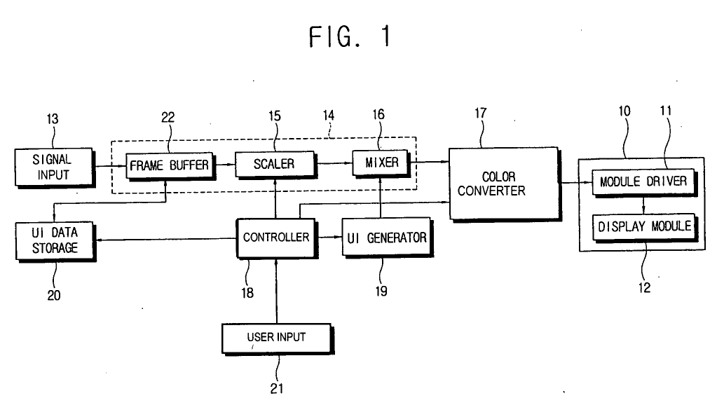

FIG. 1 shows a display system according to an embodiment of the present invention. The display system comprises a display 10 which displays an image, a signal processor 14, a signal input 13, a color converter 17, and a controller 18 which controls the foregoing components. According to an aspect of the present invention, a user interface (UI) generator 19, a UI data storage, and a user input are also provided as described below.

The display 10 displays an image according to an image signal output from the color converter 17. The display 10 comprises a display module 12 which displays the image, and a module driver 11 which processes the image signal output from the color converter 17 and enables the image to be displayed in the display module 12. It is understood that the display module 12, according to an aspect of the present invention, may be one of a variety of display modules known or to be known, for example, a CRT (Cathode Ray Tube), a DLP (Digital Light Processing) display, an LCD (Liquid Crystal Display), a PDP (Plasma Display Panel), and the like. Accordingly, where the display module 12 is a DLP display, the module driver 11 may include an optical engine, and where the display module 12 is an LCD, the module driver 11 may include a printed circuit board that converts an image signal output from the color converter 17 into a data signal or a gate signal. That is, the display 10 may comprise different components, for example, a different module driver 11, corresponding to the type of the display module 12.

The signal processor 14 converts an image signal output from the signal input 13 into a displayable image signal for the display 10. The signal processor 14, according to the present invention, can be variously formed depending on the type of the display module 12. For example, where the display module 12 is one of an LCD, a PDP, and a DLP display, the signal processor 14 may comprise a scaler 15 that scales a digital image signal, as shown in FIG. 1. The signal processor 14 may further comprise a frame buffer 22 which temporarily stores the image signal input through the signal input 13 and outputs it to the scaler 15. Where the display module 12 is a CRT, the signal processor 14 may comprise an amplifier (not shown) that amplifies the image signal input through the signal input 13, and horizontal/vertical deflectors (not shown) that deflect an electron beam based on vertical and horizontal synchronizing signals.

The signal input 13 receives the image signal, and then outputs it to the signal processor 14. The signal input 13 is also formed depending on the type of the display module 12. For example, where the signal processor 14 processes a digital image signal, the signal input 13 may comprise an A/D (Analog to Digital) converter (not shown) and/or other components to assist an LVDS (Low Voltage Differential Signaling) or a TMDS (Transition Minimized Differential Signal) interface to process the digital image signal. Where the display system according to an aspect of the present invention receives a TV signal, a tuner (not shown) is provided in the signal input 13.

The controller 18 controls the signal processor 14, the color converter 17, and the signal input 13. The controller 18 according to an aspect of the present invention controls the color converter 17 to convert the image signal output from the signal processor 14 based on a key signal input through a user input part 21 (to be described later).

According to an aspect of the present invention, the color converter 17 converts the image signal output from the signal processor 14 to enable colors which are displayed in the display 10 and distributed in at least one color area (CA1, CA2, CA3) grouped by a plurality of colors, in a color space (CS) to be converted within the color area (CA1, CA2, CA3).

Here, to logically describe color, the CS refers to all colors represented in a three dimensional coordinates system. The YCbCr color space is an example of a CS. Also, the CIELAB (L*a*b*) or CIELCH (L*c*h*) color space disclosed by Commission International de Eclairage (CIE) may be used as the CS. It is understood that other color spaces may be used without departing from the principles and spirit of the present invention.

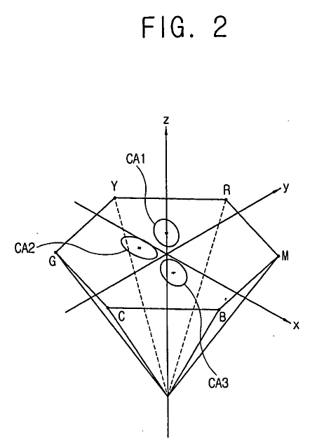

FIG. 2 depicts a YCbCr color space being used as the CS, and shows the CS formed by a relationship between brightness, hue, and saturation of a color using an XYZ coordinate system. Here, where a color space phase is changed in the XZY coordinates system, the color is also changed, and where a distance between a zero point and a coordinate X, Y, or Z is changed, saturation of the color is changed. Also, where a coordinate Z of the CS is changed centering on a zero point, the brightness of the color is changed. The CS according to an embodiment of the present invention uses six axes formed by six basic colors: R (Red), Y (Yellow), G (Green), C (Cyan), B (Blue), and M (Magenta).

A color area is defined by, for example, grouping a plurality of colors distributed in a CS. The three color areas CA1, CA2, and CA3 in FIG. 2 are each defined by grouping a plurality of colors distributed in the CS. The color converter 17 of the present invention recognizes the color areas CA1, CA2, and CA3 by calculating them using a geometric equation in the XYZ coordinate system. For example, where the color areas CA1, CA2, and CA3 are elliptically shaped in the XYZ coordinate system, the color converter 17 recognizes the color areas CA1, CA2, and CA3 by calculating them using an elliptical equation.

According to an aspect of the present invention, the color areas CA1, CA2, and CA3 may comprise memorial color areas defined according to a distribution of memorial colors. Here, a memorial color area refers to a particular color, or a combination of colors of a certain object/thing that a user is accustomed to and/or perceives as what the color of the object/thing should be in his/her memory. It is understood, for example, that while a skin-tone color, a grass/tree-green color, and a sky-blue color are exemplified, the present invention may be applied with respect to other memorial color areas. Referring to FIG. 2, a distribution of a memorial color area is generally an ellipse-like shape in the CS formed by the relationship between brightness, hue, and saturation, and the color areas CA1, CA2, and CA3 in FIG. 2 correspond to the memorial color areas, that is, the skin-tone color, the grass/tree-green color, and the sky-blue color, that are defined based on the distribution of respective memorial colors.

According to an aspect of the present invention, a color change is provided within a color area in a color space, and the color area may be of a geometric shape that is not formed of a linear combination of axes of the color space, that is, for example, an area between two lines in a coordinate system of the color space. Accordingly, while not specifically disclaimed, the color change is provided within the color area and the color area need not be moved within the color space to facilitate a color change of an image.

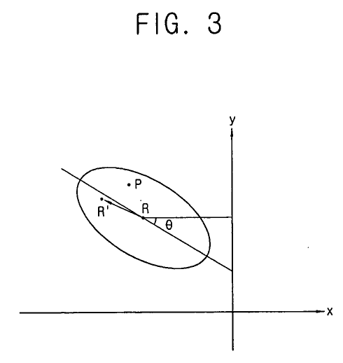

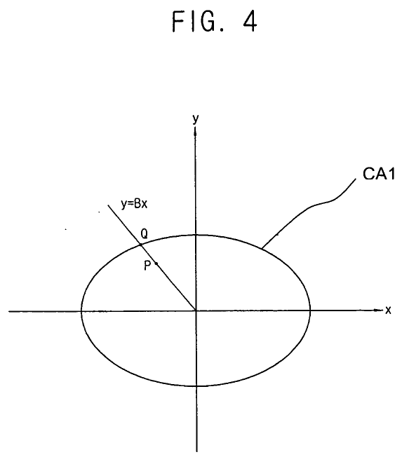

Referring to FIGS. 3 through 5, a color conversion method according to an aspect of the present invention is described below. As an illustration, the method exemplifies a conversion of hue and saturation in the color converter 17. Here, the color area (CA1, CA2, CA3) in the color space (CS) is exemplified in parallel to an X-Y plane. That is, even though a color is converted in the color area (CA1, CA2, CA3), brightness of the color is not being changed. In this case, the color converter 17 changes hue and saturation of the color in the image signal by converting a color difference signal that represents hue and/or saturation of the color in the image signal output from the signal processor 14. As shown in FIGS. 3 and 4, the color area CA1 is elliptically shaped. The corresponding elliptical equation and coordinates use X and Y coordinates of the XY coordinate system.

The following terminology and parameters are used to describe the color conversion method:

<Terminology>

| | |
|---|---|
| standard color: | a predetermined color to determine a |
| | degree of color change of other |
| | colors in a color area |

<Parameters>

| | |
|---|---|
| m1 = cos(−θ), m2 = sin(−θ): | a parameter for a rotation angle of an |
| | ellipse |
| f, g: | a parameter for an elliptical equation |
| R(xr, yr): | a coordinate value of the standard color |
| R′(xr′, yr′): | a color conversion coordinate value of |
| | the standard color |

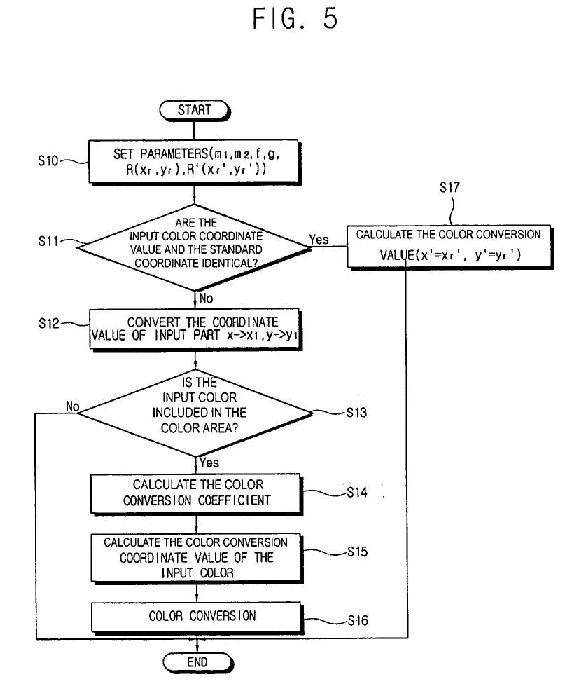

Referring to FIG. 5, in operation S10, parameters (m1, m2, f, g, R(xr, yr), and R′(xr′, yr′)), used for the color conversion by the color converter 17, are set. That is, the parameters are predetermined/preset in the operation S10. Where the image signal from the signal processor 14 is input, the input image signal is divided into a luminance signal and a chrominance signal that define brightness. In operation S11, the color converter 17 checks whether a coordinate value (P(x,y)) of a color (hereinafter, “input color”), corresponding to a color difference signal, and a coordinate value (P(xr, yr)) of the standard color are identical. Where the values are identical, the color conversion coordinate value (P(x′,y′)) of the input color becomes the color conversion coordinate value (P(xr′, yr′)) of the standard color, in operation S17.

Where the coordinate value (P(x,y)) of the input color and the coordinate value (P(xr, yr)) of the standard color are not identical, the coordinate value (P(x,y)) of the input color is converted into a coordinate value (P(x1, y1)) in a coordinate system that is set based on the longest axis and the shortest axis of the ellipse defining the color area CA1, in operation S12. Here, the conversion of the coordinate value (P(x,y)) of the input color is calculated using Equation 1:

$$[ \begin{matrix}x1 \\ y1\end{matrix} ] = [ \begin{matrix}m1 & - m2 \\ m2 & m1\end{matrix} ] [ \begin{matrix}x - xr \\ y - yr\end{matrix} ] \qquad Equation 1$$

In operation S13, a determination is made as to whether the input color is included in the color area CA1 using Equations 2 and 3 below. The Equation 2 is an ellipse equation to define the color area CA1 in the new coordinate system set based on the longest axis and the shortest axis of the ellipse forming the color area CA1 of FIG. 3, as shown in FIG. 4. Since the coordinate value (P(x,y)) is converted in the operation S12, Equations 2 and 3 may be simply calculated based on the coordinate system of FIG. 4.
f×x²+g×y²=1 Equation 2
f×x1²+g×y1²≦1 Equation 3

Where the input color is not included in the color area CA1, the color converter 17 outputs the color difference signal as is, corresponding to the input color, to the display 10. Where the input color is included in the color area CA1, the color converter 17 outputs a color conversion coefficient (a) for the color conversion of the coordinate value (P(x1, y1)) of the input color, in operation S14. The color conversion coefficient (a) is calculated using Equations 4 and 5 below:

$$r = \sqrt{{xc}^{2} + {yc}^{2}} = \sqrt{\frac{1 + {B}^{2}}{f + g \times {B}^{2}}} \qquad Equation 4$$

$$( B = \frac{y1}{x1} ,$$

if x1 is 0, then

$${r}^{2} = \frac{1}{g} ,$$

if y1=0, then

$${r}^{2} = \frac{1}{f} ,$$

(xc, yc) is a coordinate value of Q)

$$a = \frac{r - \sqrt{{( x - xr )}^{2}} \times {( y - yr )}^{2}}{r} \qquad Equation 5$$

In operation S15, the color conversion coordinate value (P(x′, y′)) of the input color is calculated using Equation 6 below:

$$[ \begin{matrix}{x}^{′} \\ {y}^{′}\end{matrix} ] = [ \begin{matrix}x \\ y\end{matrix} ] + a [ \begin{matrix}{xr}^{′} - xr \\ {yr}^{′} - yr\end{matrix} ] \qquad Equation 6$$

Where the color conversion coordinate value (P(x′, y′)) of the input color is calculated, the color converter 17 converts the color difference signal corresponding to the calculated color conversion coordinate value, and outputs it to the display 10, in operation S16.

Referring back to FIG. 1, the display system according to an aspect of the present invention further comprises the UI (User Interface) generator 19 which provides a user interface through which a user can convert the colors distributed in the color area CA1. Here, image signals corresponding to a particular user interface output from the UI generator 19 are input to a mixer 16 of the signal processor 14. The mixer 16 mixes the image signals input from the signal processor 14 and the UI generator 19, and outputs it to the color converter 17.

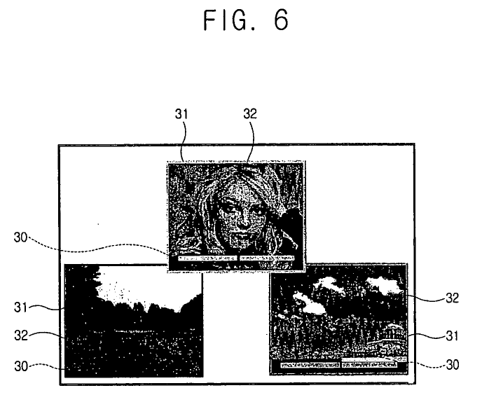

Referring to FIG. 6, the user interface according to an aspect of the present invention includes a color controller 30, which is controlled through a screen, and/or a converted image display window 31, which displays a converted image 32. For example, by controlling the color controller 30, the user may convert the colors distributed in the color area CA1. Here, where the color controller 30 is controlled by the user, the color conversion coordinate value (R′(xr′, yr′)) of the aforementioned standard color is changed, and a display condition of the converted image 32 displayed in the converted image display window 31 is changed corresponding to an operation of the color controller 30. Therefore, the converted image 32 includes corresponding colors distributed in the color area CA1.

Referring back to FIG. 1, the display system according to an aspect of the present invention further comprises the user input 21 which applies a key signal to the controller 18 to convert the colors distributed in the color area CA1. The key signal corresponds to, for example, a user interface operation of the color controller 30 to convert the colors distributed in the color area CA1. According to an aspect of the present invention, the user input 21 comprises an OSD button provided in a front side of the display system, a keyboard or a mouse of a computer connected to the display system, and/or a remote controller.

FIGS. 6 through 8 further illustrate user interfaces according to aspects of the present invention.

As shown in FIG. 6, the user interface includes the converted image windows 31 corresponding to the color areas CA1, CA2, and CA3, and the converted images 32, each having colors distributed in a corresponding one of the color areas CA1, CA2, and C3. The converted images 32 are displayed in the respective converted image display windows 31.

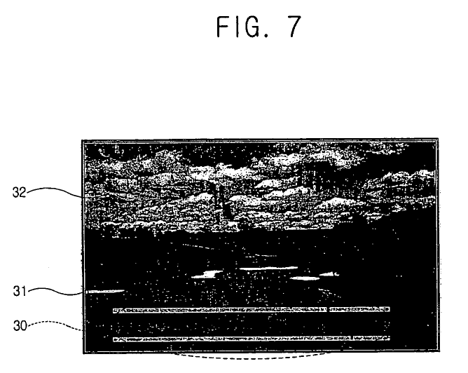

The user interface in FIG. 7 displays a plurality of the color controllers 30. Correspondingly the converted images having the colors distributed in a plurality of the color areas CA1 and CA2, in one converted image display window is present. Furthermore, it is desirable to include a face of the person distributed corresponding to the color area CA3, in the converted images of FIG. 7. The converted image display window 31 may include less than all of the converted images 32, in which case the color controller 30 corresponding to the non-displayed converted image may be inactive or not displayed. According to an aspect of the present invention, the color controllers 30 are displayed outside of the converted image display window 31. According to an aspect of the present invention, the utilization of the color controllers 30 is optional.

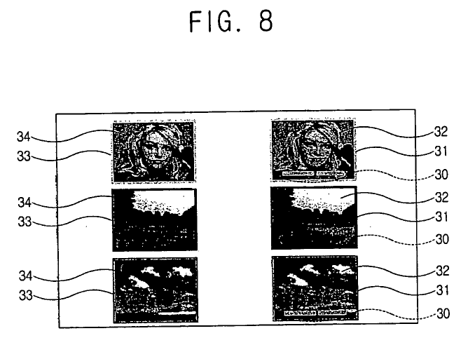

The user interface illustrated in FIG. 8 comprises standard image display windows 33 which display standard images 34 corresponding to, for example, the converted images 32 prior to conversion. Each of the standard images 34 displayed in the respective standard image display windows 33 includes colors distributed in a corresponding one of the color areas CA1, CA2, and CA3, and for a comparison, the colors are not changed by the respective one of the color controllers 30. For example, a control of a color controller 30 converts colors distributed in a color area (CA1, CA2, or CA3), thereby changing an image 32 displayed in a respective converted image display window 31 in real time. Here, the state of the corresponding standard image 34 is not changed to facilitate the comparison.

According to an aspect of the present invention, data, for example, data related to interfaces of the converted images 32 and the standard images 34, is stored in the UI data storage 20, as shown in the display system of FIG. 1. While not limited thereto, a flash memory may be used for the UI data storage 20. The UI data storage 20 outputs the data of the interfaces such as the converted image 32 and the standard image 34 to the frame buffer 22 of the signal processor 14 as controlled by the controller 18.

While the color areas CA1, CA2, and CA3 are described as an elliptical shape in the foregoing aspects, it is understood that they may be of various geometric shapes including complex geometric shapes. It is also understood that while color areas CA1, CA2, and CA3 have been described with respect to skin-tone color, grass/tree-green color, and sky-blue color, other color areas corresponding to other colors may be provided. For example, other color areas may be provided for other skin-tone colors.

Furthermore, while the controller 18 has been described as outputting the interface data of the standard images 34 stored in advance in the UI data storage 20, to facilitate the user interface, the controller 18 may adopt data from any image in the image signal input to the frame buffer 22 from the signal input 13 as a standard image for the user interface. Also, the controller 18 may adopt data of any image in the image signal as data of a standard image to store it in the UI data storage 20, and display it to the corresponding standard image display window 33. The controller 18 may likewise adopt data of an image obtained through a network, such as the Internet, for the user interface. The same may apply with respect to the standard images 34 for the user interface.

In addition, while a user interface has been described with respect to color change in a color area in a color space, it is understood that the user interface aspect of the present invention can be applied to facilitate a color change with respect to a display system capable of color change using known or to be known color changing apparatuses and/or methods.

As described the above, the display system according to the present invention allows a conversion in color of an image, the color being distributed only in a certain color area in a color space, and applies the change to an image or an image stream for display. The settings corresponding to a user desired conversion may be stored for later applications.

Because conversion in color for the colors distributed in the color area occurs within the color area, the display system of the present invention prevents discontinuity of the colors caused by conversion in color. That is, the display system minimizes the number of colors not displayed therein. Also, since colors distributed only in a predetermined color area are changed, other colors and/or color areas are not affected.

According to an aspect of the present invention, using an XYZ coordinate system for the color conversion, the color areas are formed in various geometric shapes, and calculations for the conversion are performed with ease, while not specifically disclaimed, without, for example, using a look up table. It is understood that the present invention is not limited to the six basic colors, and as described above, not limited to a color area comprising a linear combination thereof, that is, the color areas may be formed of complex geometric shapes. In other words, while not specifically disclaimed, a color area of the present invention need not be within a linear combination of colors with respect to axes of a color space.

It is understood that a system which uses the present invention may also include permanent or removable storage, such as magnetic and optical discs, RAM, ROM, etc., on which the process and data structures of the present invention can be stored and distributed. The operations can also be distributed, for example, via downloading over a network such as the Internet.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A display system to display an image according to an image signal, the display system comprising a color converter to convert the image signal by changing a color distributed in a color area grouped by a plurality of colors and formed as a geometric shape in a color space.

2. The display system of claim 1, wherein the color converter sets a predetermined color in the color area as a standard color, and determines a color conversion degree of the other colors in the color area based on a color conversion degree of the standard color.

3. The display system of claim 1, wherein the color space is one of a YCbCr color space, a CIELAB (Commission International de Eclairage L*a*b*) color space, and a CIELUV (Commission International de Eclairage L*u*v*) color space.

4. The display system of claim 1, wherein the color converter changes one or more color components and/or a saturation of the color in the color area.

5. The display system of claim 1, wherein:
the image signal comprises a luminance signal and a chrominance signal, and
the color converter converts the chrominance signal to change the color in the color area.

6. The display system of claim 1, wherein the color area comprises a memorial color area having memorial color components, the memorial color area being a color of a certain object that a user is accustomed to and/or perceives as the color of the object.

7. The display system of claim 6, wherein the color area forms an elliptical shape in the color space.

8. The display system of claim 1, further comprising a user interface generator which provides one or more user interface components to visually confirm and accommodate the change of the color distributed in the color area.

9. The display system of claim 8, further comprising a user input which operates one or more of the user interface components and generates a key signal to convert the color in the color area.

10. The display system of claim 8, further comprising:
a display which displays the image;
a signal processor which processes input image data into the image signal in a displayable form;
a user interface data storage which stores one or more of the user interface components.

11. The display system of claim 10, further comprising a controller which uses one or more image components of the image and/or one or more components obtained via a network as one or more of the user interface components.

12. The display system of claim 1, wherein the color converter changes the color distributed in the color area according to a predetermined setting obtained via a network.

13. The display system of claim 8, wherein the user interface generator provides:
one or more color control bars to control the change of colors distributed in the color areas; and
a converted image display window, having one or more converted images corresponding to the one or more color areas, to visually confirm and accommodate the change of colors distributed in the color areas.

14. The display system of claim 8, wherein:
the user interface generator provides one or more converted image display windows corresponding to the one or more color areas, and
each of the converted image display windows includes a converted image and a color control bar to accommodate and visually confirm the change of colors distributed in the color areas when the respective color control bars are operated.

15. The display system of claim 14, wherein:
the user interface generator further provides one or more standard image display windows corresponding to the one or more color areas, and
each of the standard image display windows includes a standard image corresponding to a respective one of the converted images so as to visually facilitate a before and after comparison.

16. A display system to display an image resulting from an image signal, comprising a user interface generator which provides one or more user interface components to visually confirm and accommodate a change in color distributed in a color area grouped by a plurality of colors and formed as one of a variety of geometric shapes in a color space.

17. A display system of claim 16, wherein the user interface generator provides:
one or more color control bars to change the colors distributed in the color areas; and
a converted image display window, having one or more converted images corresponding to the one or more color areas, to visually confirm and accommodate the change of colors distributed in the color areas.

18. The display system of claim 16, wherein:
the user interface generator provides one or more converted image display windows corresponding to the one or more color areas, and
each of the converted image display windows includes a converted image and a color control bar so as to visually confirm and accommodate the change of colors distributed in the color areas by operating the respective color control bars.

19. The display system of claim 18, wherein the user interface generator provides one or more standard images corresponding to the one or more converted images for a before and after comparison.

20. A method of operating a display system to display an image resulting from an image signal, the method comprising:
providing one or more user interface components requesting a user operation to change a color distributed in a color area grouped by a plurality of colors and formed as one of a variety of geometric shapes in a color space, in response to a user preference key signal; and
presenting the one or more user interface components to visually indicate the color change according to the user operation.

21. The method of claim 20, further comprising converting the image signal according to a conversion setting corresponding to the user operation.

22. The method of claim 21, wherein the converting of the image signal includes setting a predetermined color in the color area as a standard color, and determining a color conversion degree of the other colors in the color area based on a conversion degree in the standard color.

23. The method of claim 21, wherein the converting of the image signal comprises at least one of changing one or more color components of the color area, changing a saturation of the color area, and converting a chrominance signal of the image signal, to change the color distributed in the color area.

24. The method of claim 20, further comprising:
processing the image signal according a conversion setting in response to the user operation; and
processing the image signal according to a predetermined setting in response to a signal indicating a preference for a preset color change in the color area.

25. The method of claim 20, wherein:
the providing of the one or more user interface components includes providing an operable color control bar and a converted image display window having a converted image corresponding to the color area, so as to visually confirm and accommodate the color change, and
the presenting of the one or more user interface components includes implementing the color change to the converted image display in real time.

26. The method of claim 25, wherein the providing of the one or more user interface components further includes providing a standard image display window having a standard image corresponding to the converted image so as to facilitate a before and after comparison.

27. A method of changing a color distributed in a color area grouped by a plurality of colors and formed as one of a variety of geometric shapes in a color space, the method comprising:
converting an input coordinate value of an input color corresponding to a color difference signal into a converted coordinate value in a coordinate system that is set based on longest and shortest axis of a geometric shape defining the color area, in response to the input coordinate value not being identical to a coordinate value of a predetermined standard color, wherein the color difference signal is indicative of hue and/or saturation of the color;
determining a color conversion coefficient for a color conversion of the converted coordinate value and a color conversion coordinate value of the input color in response to the input color not being included in the color area; and
converting the color difference signal corresponding to the determined color conversion coordinate value.

28. A method of user interfacing to controllably display an image resulting from an image signal for display, the method comprising:
providing one or more reference images requesting a user preferred change in color of a color area grouped by a plurality of colors and formed as one of a variety of geometric shapes in a color space; and
presenting the one or more reference images to visually indicate the change in color in real time.

29. The method of claim 28, further comprising providing one or more standard images corresponding to the one or more reference images for a before and after comparison.

30. The method of claim 28, further comprising providing one or more color control bars corresponding to the one or more color areas to provide a visual representation of a level of color change.

31. A computer readable medium encoded with operating instructions for implementing a method of operating a display system to display an image resulting from an image signal, performed by a computer, the method comprising:
providing one or more user interface components requesting a user operation to change a color distributed in a color area grouped by a plurality of colors and formed as one of a variety of geometric shapes in a color space in response to a user preference key signal; and
presenting the one or more user interface components to visually indicate the color change according to the user operation.

32. The computer readable medium of claim 31, further comprising processing the image signal according to a conversion setting corresponding to the user operation, the processing of the image signal including setting a predetermined color in the color area as a standard color, and determining a color conversion degree of the other colors in the color area based on a color conversion degree of the standard color.

33. A method in a computer system to process an image, the image resulting from an image signal, the method comprising:
controlling a user interface generator to provide one or more user interface components to visually confirm and accommodate a change in color distributed in a color area grouped by a plurality of colors and formed as one of a variety of geometric shapes in a color space within the color area; and
controlling a color converter to convert the image signals to change the color in the color area of the image.
